(19) United States
(12) Patent Application Publication
(10) Pub. No.: US 2004/0068737 A1
(43) Pub. Date: Apr. 8, 2004

(54) Method and apparatus for monitoring tv channel selecting status

(76) Inventors: Yosikazu Itoh, Chuo-ku (JP); Hiroshi Tanaka, Chuo-ku (JP); Tadayuki Aoyama, Chuo-ku (JP); Yoshikazu Aoyama, Chuo-ku (JP); Takahide Yoshioka, Chuo-ku (JP)

Correspondence Address: Jordan & Hamburg, 122 East 42nd Street, New York, NY, 10168, US

(21) Appl. No.: 10/467,147

(22) PCT Filed: Feb. 12, 2003
(86) PCT No.: PCT/JP03/01408

(30) Foreign Application Priority Data
Feb. 19, 2002 (JP) 2002-41156

(51) Int. Cl. H04H 9/00; H04N 7/16

(52) U.S. Cl. 725/14; 725/18; 725/19

(57) ABSTRACT

A monitoring apparatus (3) which is used to monitor the channel actually selected by a TV set (1). A reference tuner (32) independently reproduces and output an audio signal of the channel to be monitored. An audio comparison part (31) compares the feature parameter of an audio signal from a loudspeaker output terminal (13) of the TV set and the feature parameter of the audio signal from the reference tuner to detect whether or not the both signals coincide with each other. A remote control signal receiving part (34) receives a signal from a TV remote control signal transmitter (2) to obtain information of a channel to be switched to. At the time of changing the channel of the reference tuner until coincidence is detected in the audio comparison part, a control part (37) indicates first to the reference tuner the channel to be switched to identified by the remote control signal part, thereby permitting fast and accurate monitoring of the channel being selected by the TV set.

### TECHNICAL FIELD

The present invention relates to a TV channel selecting status monitoring method and apparatus for monitoring the channel to which the TV set is being actually tuned.

### BACKGROUND ART

A variety of methods has been proposed or put to practical use to monitor the channel selecting status of the TV set placed at each sample household for the purpose of audience rating measurement; one of the prior art methods utilizes audio signals. According to this method, a comparison is made between feature parameters of the audio signal being reproduced by the TV set and the audio signal reproduced by a reference tuner provided separately of the TV set, then the reference tuner is switched from one channel to another until the parameters coincide with each other, and the channel for which they coincide specified as the currently selected channel. This method will hereinafter be referred to as a first conventional method. The first conventional method is described, for example, in Japanese Pat. Appln. Pub. Gazette No. 308711/98. Further, Japanese Pat. Appln. Pub. Gazette No. 327017/95 describes a method that measures the audience rating by comparing frequency spectra of both of a car radio and a reference radio.

On the other hand, almost every home now solely uses a remote control signal transmitter for channel selection instead of using a channel switch button on the TV set. To meet such a situation, another conventional method for monitoring the actually selected TV channel receives and analyzes an infrared signal emanating from an infrared TV remote control by a monitor placed near the TV set. This method utilizes the fact that the infrared signal emanating from the remote control propagates while spreading out to some extent and hence can be captured by the monitor if it is placed in the vicinity of the TV set. This method will hereinafter be referred to as a second conventional method. Literature on the second conventional method is Japanese Pat. Appln. Pub. Gazette No. 275607/99.

In addition to conventional analog terrestrial broadcasting, BS digital broadcasting has begun and digital terrestrial broadcasting will also become operational in the near future, ushering in a full-scale multi-channel era. At the same time, TV sets capable of receiving plural kinds of broadcasting, such as the analog terrestrial broadcasting and the BS digital broadcasting, have been developed and some of them are already placed on the market. With an increase in the number of channels that can be received by one TV set, the number of channels to be monitored increases accordingly, giving rise to the problem that the above-mentioned first conventional method consumes much time to specify the channel being tuned. In particular, the digital broadcasting decodes audio signals by MPEG-2 AAC (Advanced Audio Coding), and hence it takes a larger amount of time for decoding than does the analog broadcasting. For example, letting the number of channels to be monitored be represented by n and the time for monitoring each channel by t, the first conventional method takes as much time as n×t at worst and one half even on an average.

With the second conventional method, the infrared signal from the infrared remote control may sometimes be received by the TV set or monitor alone according to the direction of the infrared remote control or due to the presence of an obstacle to the propagation of the infrared signal—this increases the probability that the channel recognized by the monitor as the currently selected channel differs from the channel actually received by the TV set. The TV viewer cannot usually recognize this discrepancy and hence has no chance of resolving it, leaving the monitoring error uncorrected for a long time. Furthermore, when the channel is tuned by use of the channel switch button attached to the TV set in place of the remote control, it is impossible to monitor the channel selecting status.

On the other hand, the conventional analog terrestrial broadcasting in our country uses the NTSC video format, whereas the digital broadcasting employs a wide variety of video formats. For example, BS digital broadcasting adopts four kinds of video formats, i.e. 480i, 480p, 720p and 1080i, according to differences in the number of effective scanning lines and in the scanning scheme used. TV receivers come in two types, one of which is automatically switched to the received video format to provide a video display on the display screen, and the other of which uses one or two limited display scanning schemes and displays the received video after its format conversion by signal processing in accordance with the selected scanning scheme. For example, the formats 480i, 480p, 720p and 1080i are all converted to 480i. That is, the situation arises where video is not always displayed intact in the broadcast format. On this account, from the viewpoint of adding value to the audience rating survey, too, it is desirable to detect the kind of the format of video actually displayed on the TV screen and contain the information in audience rating survey data.

Accordingly, it is an object of the present invention to permit fast and accurate determination of the channel actually received by the TV set.

Another object of the present invention is to permit detection of the kind of the format of video actually displayed on the TV screen.

### DISCLOSURE OF THE INVENTION

According to a first aspect of the present invention, there is provided a TV channel selecting status monitoring method which identifies the channel being actually received by a TV set which has at least one built-in tuner and TV-side remote control signal receiver means for receiving and identifying a remote control signal from a remote control signal transmitter and controlling the channel tuning status of said built-in tuner and which provides video and audio signals of the currently selected channel to a display and a loudspeaker, respectively, said method comprising the steps of: (a) receiving and identifying the signal from said remote control signal transmitter and determining the channel being received by said TV set; and (b) controlling the channel tuning status of a reference tuner to bring said audio signals from said reference tuner and said loudspeaker of said TV set into coincidence, said reference tuner being capable of outputting an audio signal of an arbitrary one of a predetermined number of channels. Said step (b) comprises the steps of: (b-1) upon each occurrence of noncoincidence between said audio signals, switching said reference tuner from the channel determined in said step (a) to another one of the predetermined number of channels in a sequential order until said both audio signals coincide with each other; (b-2) determining, as the currently selected channel, the channel being tuned by said reference tuner at the time when said both audio signals coincide again; and (b-3) storing in storage means selected-channel data containing information about said channel determined as being currently tuned and the corresponding time information.

According to a second aspect of the present invention, the TV channel selecting status monitoring method of the first aspect further comprises the step (c) of detecting the kind of the format of the video displayed on said display of said TV set, the video format detected in said step (c) being added to the selected-channel data to be stored in said storage means in said step (b-3).

According to a third aspect of the present invention, in the TV channel selecting status monitoring method of the second aspect, said step (c) comprises the steps of: (c-1) detecting a horizontal sync signal applied to said display of said TV set; (c-2) counting the period of said horizontal sync signal detected in said step (c-1); and (c-3) determining the kind of the format of video currently displayed on said display on the basis of the count value obtained in said step (c-2).

According to a fourth aspect of the present invention, in the TV channel selecting status monitoring method of the first aspect, said step (b) further comprises the step (b-4) of writing information about the currently selected channel determined in said step (b-2) in a channel information storage part, and said step (a) comprises the steps of: (a-1) determining the channel to be switched to on the basis of the result of identification of the signal received from said remote control signal transmitter and the currently selected channel information stored in said channel information storage part; and (a-2) writing information about the channel determined in said step (a-1) in said channel information storage part.

According to a fifth aspect of the present invention, in the TV channel selecting status monitoring method of the first aspect, said step (b-1) is a step of: calculating the frequency spectrum of the audio signal from said reference tuner and the frequency spectrum of the audio signal from said loudspeaker of said TV set; and comparing the both frequency spectra, to thereby determine whether or not the audio signal from said reference tuner and the audio signal from said loudspeaker of said TV set coincide with each other.

According to the first aspect of the present invention, there is provided a TV channel selecting status monitoring apparatus which identifies the channel being actually received by a TV set which has at least one built-in tuner and TV-side remote control signal receiver means for receiving and identifying a remote control signal from a remote control signal transmitter and controlling the channel tuning status of said built-in tuner and which provides video and audio signals of the currently tuned channel to a display and a loudspeaker, respectively, said apparatus comprising:

a reference tuner capable of outputting an audio signal of an arbitrary one of a predetermined number of channels;

audio comparison means for detecting whether or not the audio signal from said loudspeaker of said TV set and the audio signal from said reference tuner coincide with each other;

monitor-side remote control signal receiver means for receiving and identifying a signal from said remote control signal transmitter to determine the channel currently selected by said TV set;

control means which: controls the channel tuning status of said reference tuner so that the output from said audio comparison means remains coincidence-detected; when the coincidence-detected output from the audio comparison means changes to a noncoincidence-detected output, switches said reference tuner from the channel determined by said monitor-side remote control signal receiver means to another one of the predetermined number of channels in a sequential order until the channel of said reference tuner is found for which coincidence is detected by said audio comparison means; determines, as the currently selected channel, the channel currently tuned by said reference tuner for which the output from said audio comparison means becomes the coincidence-detected output again; and outputs selected-channel data containing information about said channel determined as being currently selected and the corresponding time information; and

storage means for storing said selected-channel data provided from said control means.

According to the second aspect of the present invention, the TV channel selecting status monitoring apparatus of the first aspect further comprises video format detecting means for detecting the kind of the format of video displayed on said display of said TV set, said control means adding the output from said video format detecting means to said selected-channel channel data.

According to the third aspect of the present invention, in the TV channel selecting status monitoring apparatus of the second aspect, said video format detecting means comprises: sync signal detecting means for detecting a horizontal sync signal applied to said display of said TV set; a counter for counting the period of the horizontal sync signal detected by said sync signal detecting means; and format determining means for determining the kind of the format of video displayed on said display on the basis of the count value of said counter.

According to the fourth aspect of the present invention, in the TV channel selecting status monitoring apparatus of the first aspect, said monitor-side remote control signal receiver means comprises: channel information storage part in which is written the information about the currently selected channel detected by said control means; and an identification part for determining the channel to be switched to and writing information about said determined channel in said channel information storage part.

According to the fifth aspect of the present invention, in the TV channel selecting status monitoring apparatus of the first aspect;

said reference tuner is a tuner of the same kind as said built-in tuner and has: a plurality sets of a monitor-side tuner whose channel tuning status is controlled by said control means and audio demodulating means for demodulating right- and left-side audio signals from the output of said monitor-side tuner, said plurality sets being equal in number to the kinds of said built-in tuners in said TV set; and a first analog switch for outputting therethrough right- and left-side audio signals provided from said audio demodulating means in that one of said plurality of sets which is specified by said control means; and

said audio comparison means comprises: a second analog switch for selecting that one of right- and left-side audio signals taken out from loudspeaker output terminals of said TV set which is specified by said control means; a third analog switch for selecting that one of right- and left-audio signals from said reference tuner which is specified by said control means; a first operator for performing a fast Fourier transform for the audio signal having passed through said second analog switch; a second operator for performing a fast Fourier transform for the audio signal having passed through said third analog switch; and a comparator for comparing the operation result by said first operator and the operation result by said second operator and for providing the comparison result as the detected output to said control means.

With the TV channel selecting status monitoring method and apparatus according to the first aspect of the present invention, at the time of sequentially comparing the audio signals being output from the loudspeaker of the TV set and the audio signals of each channel generated by the reference tuner, the channel to be switched to, obtained by receiving the signal from the TV remote control signal transmitter, is monitored first, by which the channel being selected by the TV set can be monitored quickly and accurately.

With the TV channel selecting status monitoring method and apparatus according to the second and third aspects of the present invention, since the kind of format of video displayed on the TV display can be detected by measuring the period pf the horizontal sync signal of the display and can be contained in the selected-channel data, it is possible to add value to the audience rating survey.

With the TV channel selecting status monitoring method and apparatus according to the fourth aspect of the present invention, even if the channel monitored by the monitoring apparatus differs from the channel actually received by the TV set because the signal from the remote control signal transmitter is received by the TV set or monitoring apparatus alone due to the presence of an obstacle or the like, the discrepancy is resolved by writing in the channel information storage part of the monitor-side remote control signal receiving means the information on the selected channel determined by the comparison of the audio signals. By this, the channel to be switched to can be determined correctly by the monitor-side remote control signal receiving means when the signal from the remote control signal transmitter is a signal by a channel up/down button which designates the channel immediately preceding or following the currently selected channel—this permits reduction of the time for monitoring the selected channel.

With the TV channel selecting status monitoring method and apparatus according to the fifth aspect of the present invention, since coincidence between the audio signals is detected by comparing the features of their frequency spectra, it is possible to accurately monitor the channel of the BS digital broadcasting or the like in which it is difficult to provide synchronization between reproduced audio on the part of the TV set and reproduced audio on the part of the reference tuner.

### BRIEF DESCRIPTION OF DRAWINGS

FIG. 1 is a block diagram illustrating an embodiment of the present invention.

FIG. 2 is a schematic plan view of a remote control signal transmitter.

FIG. 3 is a block diagram showing the internal configuration of a reference tuner.

FIG. 4 is a block diagram showing the internal configuration of an audio comparison part.

FIG. 5 is a block diagram showing the internal configuration of a video format detecting part.

FIG. 6 is a timing chart of the operation of the video format detecting part.

FIG. 7 is a diagram showing features of video formats NTSC-M and MUSE adopted in analog terrestrial broadcasting and 480i, 480p, 720p and 1080i adopted in BS digital broadcasting.

FIG. 8 is a block diagram showing the internal configuration of a remote control signal receiving part built in the monitoring apparatus.

FIG. 9 is an explanatory diagram of a list of channels subject to monitoring.

FIG. 10 is a flowchart depicting control operations of a control part.

### BEST MODE FOR CARRYING OUT THE INVENTION

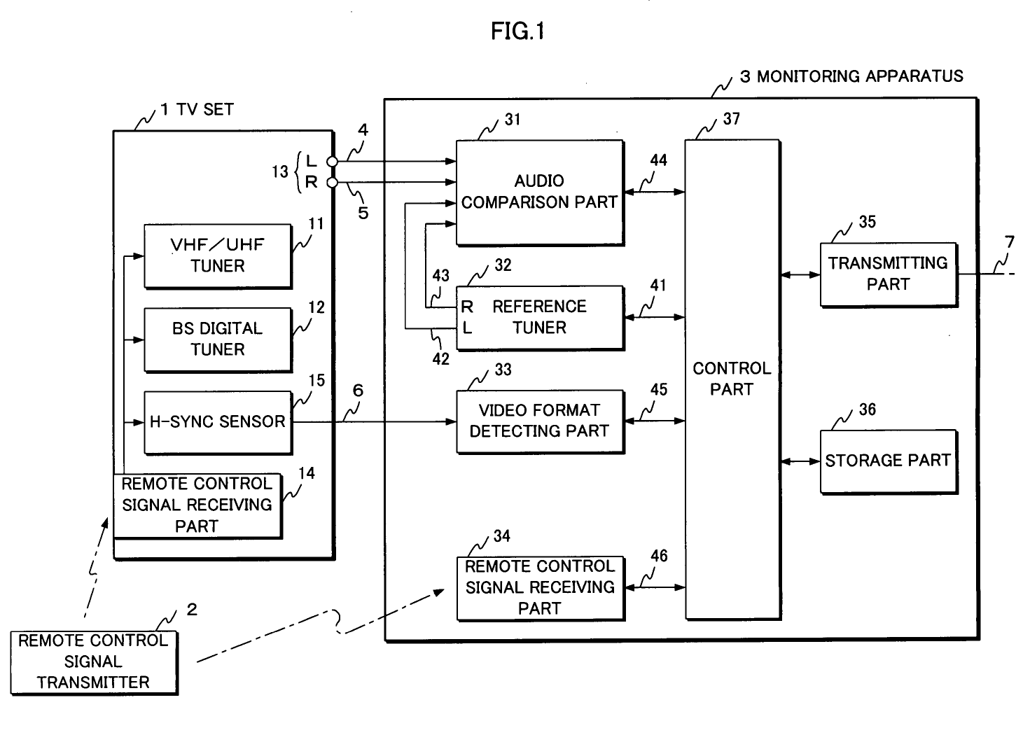

Referring to FIG. 1, the monitoring apparatus according to an embodiment of the present invention, denoted generally by 3, is connected via cables 4, 5 and 6 to a TV set 1 of a sample household, and the monitor is placed near the TV set 1 so that it can receive remote control signals from a remote control signal transmitter 2 for remote control of the TV set 1.

The TV set 1 has, as built-in tuners, a VHF/UHF tuner 11 for receiving the analog terrestrial broadcast and a BS digital tuner 12 for receiving the BS digital broadcast. Further, the TV set has loudspeaker output terminals 13 for taking out audio signals from loudspeakers not shown. The loudspeaker output terminals 13 are an L-terminal for outputting an L (left) channel audio signal and an R-terminal for outputting an R (right) channel audio signal. The L-terminal is connected via the cable 4 to the monitoring apparatus 3, whereas the R-terminal is connected via the cable 5 to the monitoring apparatus 3. Moreover, the TV set has a built-in remote control signal receiving part 14 which receives signals from the remote control signal transmitter 2 and controls the ON-OFF operation of the power supply to the TV set 1. the selection of either one of the tuners 11 and 12 and their channel tuning. An H-synchronization sensor 15 is mounted in the TV set 1 to detect the format of video displayed on a not-shown display (a Braun tube) of the TV set 1, and it detects the horizontal sync signal in the vicinity of a flyback transformer of the TV set 1 and provides the detected horizontal sync signal to the monitoring apparatus 3 via the cable 6.

The remote control signal transmitter 2 has, as shown in its schematic plan view of FIG. 1, various buttons 21 to 24 for remote control of the TV set 1, and emits an infrared signal after converting thereto a signal corresponding to the button pressed by a user. The power supply button 21 is to turn ON or OFF the power supply of the TV set 1, the volume control buttons 22 are to control volume, and the channel-select buttons 23 are to select the channel immediately preceding or following the currently selected channel. The many buttons 24 arranged in matrix form are for direct access to channels and have a one-to-one correspondence with the channels.

The monitoring apparatus 3 is connected to the TV set 1 via the cables 4 to 6, and is connected to a telephone circuit or the like via a cable 7 for sending monitored data to a center not shown. In the monitoring apparatus 3 there are provided an audio comparison part 31, a reference tuner 32, video format detecting part 33, a remote control signal receiving part 34, a transmitting part 35, a storage part 36 and a control part 37 connected to these parts.

The reference tuner 32 is a unit provided independently of the tuners 11 and 12 built in the TV set 1 to receive and demodulate the analog terrestrial broadcasting and BS digital broadcasting signals on the part of the monitoring apparatus 3. The reference tuner 32 is connected to the control part 37 via a signal line 42, and the audio comparison part 31 via signals 42 and 43. Upon receiving channel specifying information from the control part 37 via the signal line 41, the reference tuner 32 selects the channel designated by the specifying information, then demodulates at least the audio signal of the selected channel, and outputs the demodulated signal to the audio comparison part 31 via the signal lines 42 and 43. In this example, the signal line 42 transfers an L-channel audio signal and the signal line 43 an R-channel audio signal.

Referring to FIG. 3, the reference tuner 32 is provided with a terrestrial wave V/U analog tuner 321, an audio demodulating part 322, a BS digital tuner 323 and an analog switch 325. The terrestrial wave VIU analog tuner 321 selectively receives that one of VHF and UHF channels which is specified by the control part 37 via the signal line 41-2. The output signal from the tuner 321 is provided to the next-stage audio demodulating part 322, and the audio demodulating part 322 demodulates audio signals of the selected channel, and outputs the demodulated right- and left-side audio signals to the analog switch 325. The BS digital tuner 323 is a tuner that receives respective channels of the BS digital broadcast. The tuner 323 receives that one of BS channels which is specified by the control part 37 via the signal line 41-3. The output signal from the tuner 323 is applied to an MPEG-2 (ACC) decoder 324 of the next stage, and the decoder 324 demodulates audio signals of the specified channel, and outputs the demodulated right- and left-side audio signals to the analog switch 325. The analog switch 325 selects the right- and left-side audio signals from that one of the audio demodulating part 322 and the MPEG-2 (ACC) 324 which is specified by the control part 37 via the signal line 41-1, and outputs the selected audio signals to the audio comparison part 31 via the signal lines 42 and 43.

The audio comparison part 31 calculates feature parameters of the audio signals input from the loudspeaker output terminals 13 of the TV set 1 via the cables 4 and 5 and feature parameters of the audio signals input from the reference tuner 32 via the signal lines 42 and 43, and determines the degree of similarity between the feature parameters of the both input audio signals, thereby detecting whether the audio from the TV set 1 coincides with the audio from the reference tuner 32. The result of detection by the audio comparison part 31 is provided via a signal line 44 to the control part 37. The audio comparison part 31 uses, as the feature parameter of the audio signal, its frequency spectral configuration.

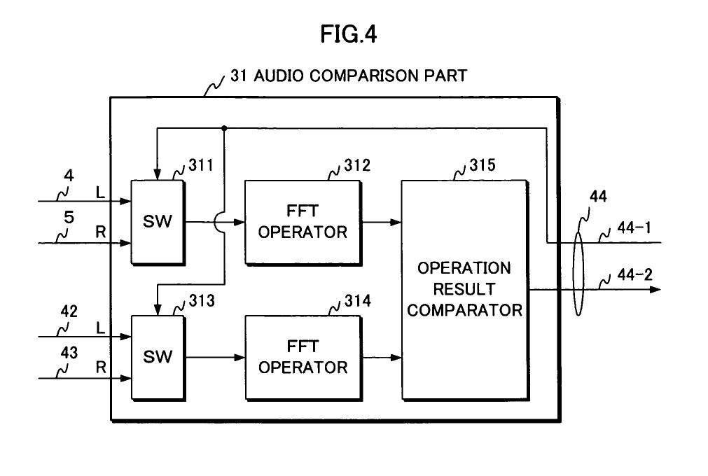

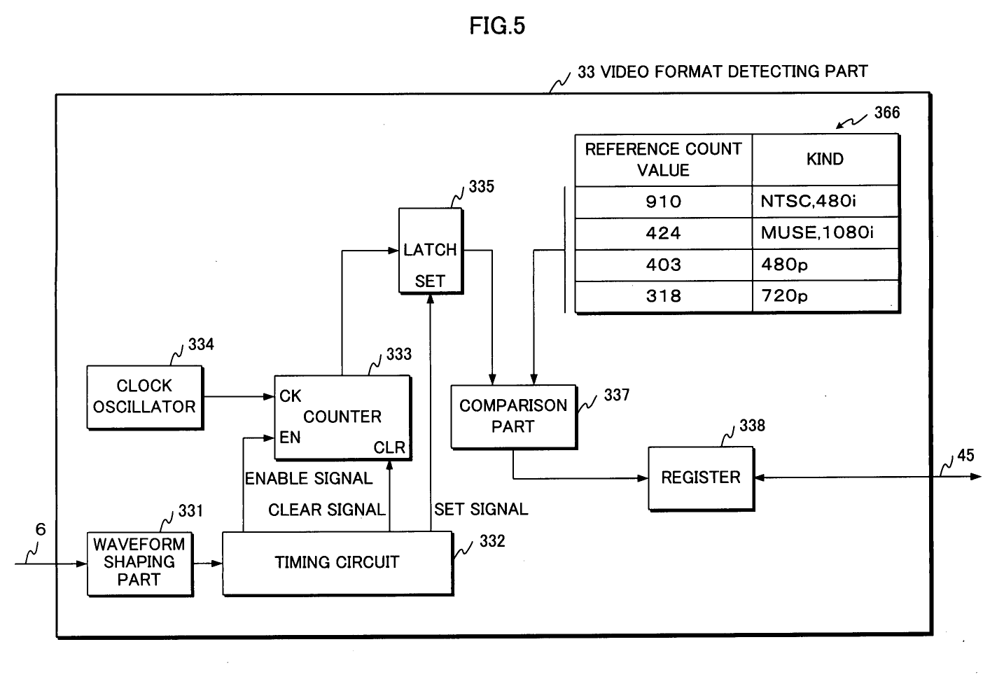

Referring to FIG. 4, the audio comparison part 31 is provided with analog switches 311 and 313, FFT operators 312 and 314, and an operation result comparator 315. The analog switch 311 inputs thereto the right- and left-side audio signals from the loudspeaker output terminals 13 of the TV set 1 via the cables 4 and 5, and when the left-side audio is specified by the control part 37 via the signal line 14-1 to be selected, the left-side audio signal from the cable 4 is provided, as an audio signal to be checked, from this analog switch to the FFT operator 312, whereas when the right-side audio is specified to be selected, the right-side audio signal from the cable 5 is provided, as an audio signal to be checked, to the FFT operator 312. The FFT operator 312 performs a fast Fourier transform of the audio signal fed thereto via the analog switch 311, and provides the resulting feature parameter, as a feature parameter to be checked, to the operation result comparator 315. On the other hand, the analog switch 313 inputs thereto the right- and left-side audio signals from the reference tuner 32 via the signal lines 41 and 43, and when the left-side audio is specified by the control part 37 via the signal line 44-1 to be selected, the left-side signal from the signal line 42 is provided, as a reference audio signal, from this analog switch to the FFT operator 314, whereas when the right-side audio is specified to be selected, the right-side audio signal from the signal line 43 is provided as a reference audio signal to the FFT operator 314. The FFT operator 314 performs a fast Fourier transform of the reference audio signal fed thereto via the analog switch 313, and provides the resulting feature parameter, as a reference feature parameter to be checked, to the operation result comparator 315. The operation result comparator 315 calculates the degree of similarity between the feature parameter to be checked from the FFT operator 312 and the reference feature parameter from the FFT operator 314, and when the degree of similarity exceeds a predetermined threshold value, the comparator provides a coincidence-detected output to the control part 37 via a signal line 44-2 and, if not, provides a noncoincidence-detected output to the control part 37 via the signal line 44-2.

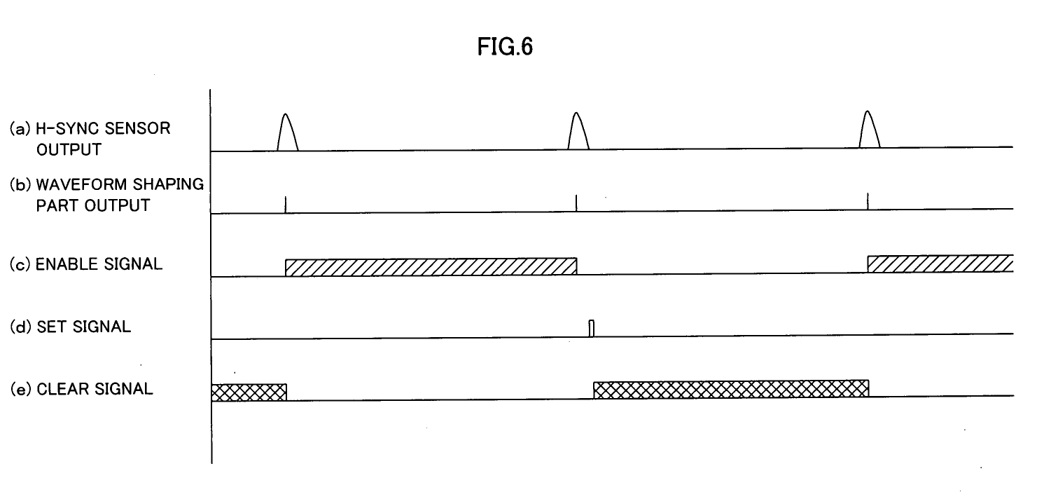

The video format detecting part 33 receives via the cable 6 the horizontal sync signal detected by the H-sync sensor 15 mounted in the TV set 1 and counts the period of the received horizontal sync signal to thereby detect the kind of the format of video displayed on the display of the TV set 1. FIG. 5 shows the internal configuration of the video format detecting part 33 and FIG. 6 its operation timing chart.

Referring to FIGS. 5 and 6, a waveform shaping part 331 inputs thereto such an output signal from the H-sync sensor 15 as shown in FIG. 6(a), and shapes its waveform, outputting such a horizontal synch signal as depicted in FIG. 6(b). A timing circuit 332 responds to each application thereto of the horizontal sync signal from the waveform shaping part 331 to invert an enable signal and a clear signal for a counter 333 relative to each other and outputs a set signal to a latch circuit 335 immediately after the fall of the enable signal as shown in FIGS. 6(c) to (e). A clock oscillator 334 generates a clock of a frequency (14.31818 MHz) four times higher than the frequency of a subcarrier. The counter 333 counts clock pulses from the clock oscillator 334 all the while the enable signal from the timing circuit 332 is high-level, that is, during every period of the horizontal sync signal. The latch circuit 335 latches the count value of the counter 33 at the timing of the latch signal from the timing circuit 332 to hold the number of clock pulses generated during each period of the horizontal sync signal. A table 336 has prestored therein a reference count value for every kind of video format. A comparison part 337 makes a check to see which of the reference count values stored in the table 336 coincides with the count value held in the latch circuit 335 with some tolerance, and sets in a register 338, as a check result, information indicating the kind of video format set in the table 338 in correspondence to the coincident reference count value. The contents of the register 338 can be read out from the control part 37 via a signal line 45.

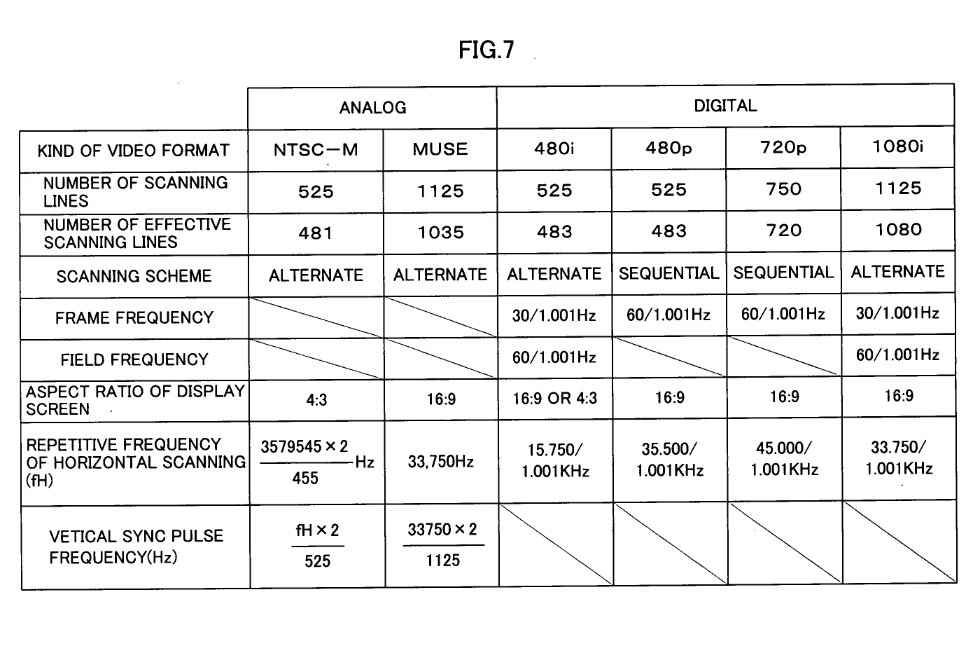

FIG. 7 shows features (number of scanning lines, number of effective scanning lines, the scanning scheme, frame frequency, field frequency, aspect ratio of display screen, repetitive frequency of horizontal scanning, vertical sync pulse frequency) of video formats NTSC-M and MUSE used in the analog terrestrial broadcasting and 480i, 480p, 720p and 1080i in the BS digital broadcasting. The video format detecting part 33 detects the video format based on the difference in the repetitive frequency of horizontal scanning which is one of the above-said features. That is, in the case of counting the clock of the frequency (14.31818 MHz) four times higher than the subcarrier for one horizontal scanning period, the count value is about 910 for NTSC-M and 480i, about 424 for MUSE and 1080i, about 403 for 480p and about 318 for 720p. Accordingly, by presetting these numerical values as reference count values in the table 360, it is possible to detect the kind of the format of video displayed on the display of the TV set 1.

The remote control signal receiving part 34 is a unit which receives and identifies the signal emanating from the remote control signal transmitter 2. Since the infrared signal emitted from the remote control signal transmitter 2 usually propagates while spreading out to some extent, the signal from the remote control signal transmitter 2 can be received easily by the remote control signal receiving part 34 placed in the vicinity of the remote control signal receiving part 14 of the TV set 1 (for example, on the cabinet of the TV set 1).

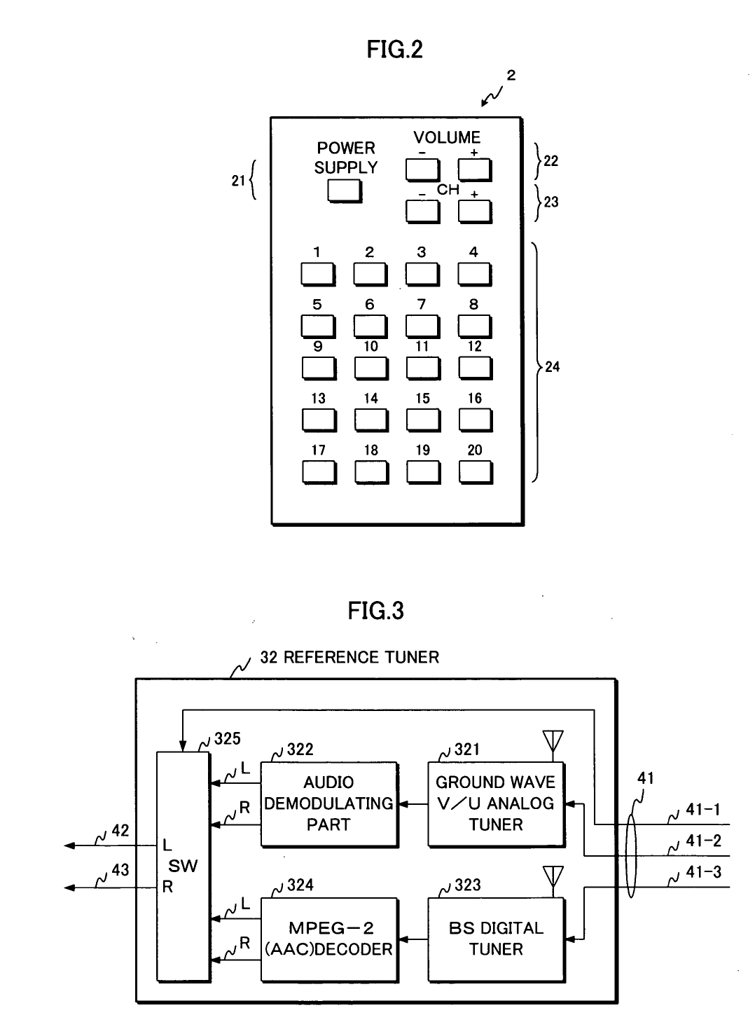

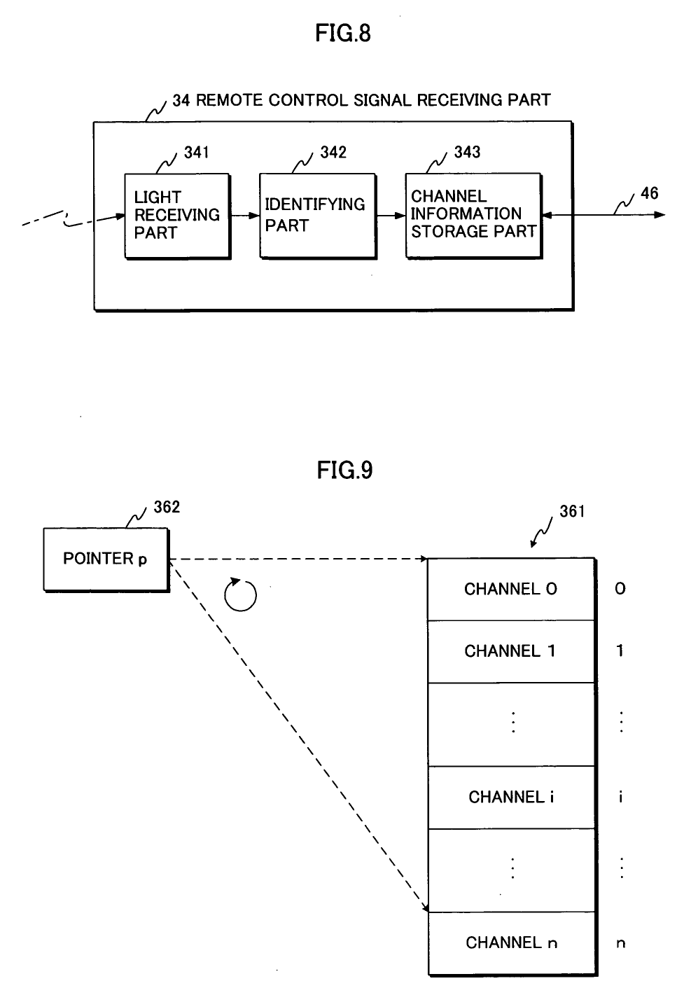

Referring to FIG. 8, the remote control signal receiving part 34 comprises a light receiving part 341, an identifying part 432 and a channel information storage part 343. The light receiving part 341 receives the infrared signal emitted from the remote control signal transmitter 2 and converts it to an electric signal, which is provided to the identifying part 342. Based on the signal pattern represented by the electric signal, the identifying part 342 identifies the operational content instructed by the user with the remote control signal transmitter 2, then determines the channel to be switched to, if necessary, by reference to channel information held in the channel information storage part 343, and stores information about the determined channel in the channel information storage part 343. For example, when having received a signal for direct selection of a particular channel by the user through manipulation of any one of the buttons 24 of the remote control signal transmitter 2 shown in FIG. 2, this remote control signal receiving part stores information on the selected channel in the channel information storage part 343. Upon receiving a signal for switching the currently selected channel to the immediately preceding or following channel through manipulation of the button 23, the remote control signal receiving part changes the channel information stored in the channel information storage part 343 to information on the immediately preceding or following channel. The contents of the channel information storage part 343 can be read out from the control part 37 via a signal line 46, and the stored contents of the channel information storage part 343 can be modified from the control part 37. The channel information storage part 343 holds its stored contents unchanged irrespective of whether the power supply of the TV set 1 is ON or OFF. Accordingly, when the power supply of the TV set 1 is turned ON, the channel information storage part holds the channel information held when the power supply was turned OFF last.

The storage part 36 is used for temporary storage of channel selecting status data obtained by the monitoring apparatus 3 and for storage of various pieces of preset information necessary for the monitoring apparatus 3. One piece of such preset information is a list of channels subject to monitoring. This is such a list 361 as shown in FIG. 9 which contains all receivable channels (Channel 0 to Channel n in this example) of analog terrestrial broadcasting and BS digital broadcasting, every entry having stored therein information about one channel. Based on this channel information, the control part 37 indicates channels one after another to the reference tuner 32. Incidentally, a pointer (p) 362 in FIG. 9 indicates that channel in the channel list 361 which is subject to monitoring next, and takes a value in the range of between 0 to n.

The transmitting part 35 is a unit from which the channel selecting status data stored in the storage part 36 is sent to a center, not shown, at a predetermined time.

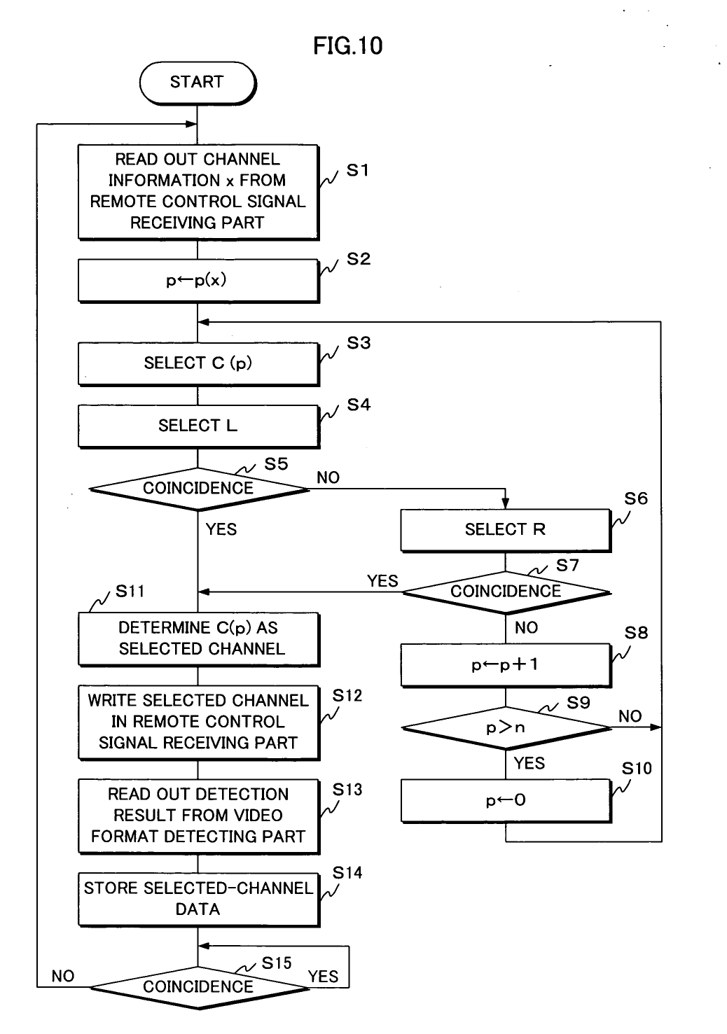

The control part 37 is a unit that controls the monitoring apparatus 3 in its entirety, and is implemented by MPU and a control program. The flow of control by the control part 37 is shown in FIG. 10.

A description will be given below of the operation of the monitoring apparatus 3 according to this embodiment.

The control part 37 starts the channel monitoring procedure of FIG. 10 with reading out via the signal line 46 the channel information (denoted by x) stored in the channel information storage part 343 of the remote control signal receiving part 34 (step SI). Next, the control part 37 sets the pointer p (362) so that it indicates that one of the channels stored in the channel list 361 which is the same channel as that indicated by the channel information x read out in step SI (step S2).

Next, the control part 37 indicates the channel information set in the pointer p to the reference tuner 32 via the signal line 41-2, causing it to receive the indicated channel (step S3). This channel is denoted by C(p). In this instance, when the channel C(p) is a channel of the analog terrestrial broadcasting, the control part 37 indicates the channel to the ground-wave V/U analog tuner 321 via the signal line 41-2 and instructs the analog switch 325 via the signal line 41-1 to select the output from the audio modulating part 322. In the case of the BS digital broadcasting channel, the control part 37 indicates the channel to the BS digital tuner 323 via the signal line 41-3 and instructs the analog switch via the signal line 41-1 to select the output from MPEG-2 (AAC) decoder 324. As a result, the left- and right-side audio signals are sent from the reference tuner 32 to the audio comparison part 31 via the signal lines 42 and 43. On the other hand, left- and right-side audio signals taken out from the loudspeaker output terminal 13 of the TV set 1 are input to the audio comparison part 31 via the cables 4 and 5.

Next, in order to compare the left-side signals first, the control part 37 instructs the analog switches 311 and 313 of the audio comparison part 31 via the signal line 44-1 to select the left-side audio signals (cable 4 and signal line 42) (step S4). As a result, the FFT operator 312 extracts, as a feature parameter to be checked, the feature parameter of the left-side audio signal provided from the TV set 1, whereas the FFT operator 314 extracts the feature parameter of the left-side signal of the channel C as a reference feature parameter. The operation result comparator 15 calculates the degree of similarity between the feature parameter to be checked and the reference feature parameter, and if the degree of similarity is below a predetermined threshold value, the comparator provides a coincidence-detected output to the signal line 44-2 and, if not, provides a noncoincidence-detected output to the signal line 44-2.

The control part 37 monitors the output from the audio comparison part 31 to see if it provides the coincidence-detected output within a predetermined time interval (Step S5), and if no coincidence-detected output is provided within the predetermined time (NO in step S5), the control part starts control to compare the right-side audio signals of the same channel C(p). In general, in the case of stereophonic broadcasting, the channel selecting status can be monitored by the left-side audio signal (L-channel audio) alone, but in the case of bilingual broadcasting or the like, there is the possibility of the viewer selecting R-channel audio that is a second audio signal. In the control for the right-side audio selection, the control part 37 instructs the analog switches 311 and 313 via the signal line 44-1 to select the right-side audio signals (cable 5 and signal line 43) (step S6). As a result, the FFT operator 312 extracts, as the feature parameter to be checked, the feature parameter of the right-side audio signal from the TV set l. whereas the FFT operator 314 extracts the right-side audio signal of the channel C(p) as the reference feature parameter. The operation result comparator 315 calculates the degree of similarity between the feature parameter to be checked and the reference feature parameter, and if the degree of similarity is below a predetermined threshold value, the comparator provides a coincidence-detected output to the signal line 44-2 and, if not, a noncoincidence-detected output to the signal line 44-2. The control part 37 monitors the output from the audio comparison part 31 to see if it provides the coincidence-detected output within a predetermined time interval (Step S7), and if no coincidence-detected output is provided within the predetermined time (NO in step S7), the control part increments the value of the pointer p by one (step S8); if the value does not exceed the maximum value x (NO in step S9), then the control part returns to step S3 and repeats the above-described processing for the next channel subject to monitoring in the channel list 361. When the value of the pointer p exceeds the maximum value x (YES in step S9), the control part sets the value of the pointer p to 0 (step S10), then returns to step S3, and repeats the above-described processing for the fist channel subject to monitoring in the channel list 361.

On the other hand, when it is found in either one of steps S5 and S7 that the audio comparison part 31 provides the coincidence-detected output, the control part 37 determines the channel C(p) as the currently tuned channel (step Sll). And the control part 37 updates the channel information in the channel information storage part 343 of the remote control signal receiving part 34 with information about the channel determined as described above (step S12). The reason for this is that the channel received and identified by the remote control receiving part 34 does not always coincide with the channel received by the TV set 1. Incidentally, when the channel information stored in the channel information storage part 343 is the same as the information of the channel determined as being selected, the control part 37 may omit updating of the channel information stored in the channel information storage part 343.

Next, the control part 37 reads out of the register 338 via the signal line 45 the video format-detected result obtained in the video format detecting part 33 (step S13). The video format-detected result read out of the video format detecting part 33 is the kind of video format of the selected channel currently displayed on the display of the TV set 1. And the control part 37 generates one piece of selected channel data and stores it in the storage part 36 (step S14). One piece of selected channel data contains the information on the selected channel, the video format-detected result and the current time.

Next, the control part 37 monitors at regular time intervals the output from the audio comparison part 31 to see if it continues outputting the coincidence-detected signal (step S15). When the user is watching the same program without changing the channel of the TV set 1, the audio comparison part 31 keeps on outputting the coincidence-detected signal, and consequently, the control part 37 stays in step S15. If the user changes the channel of the TV 1 by manipulating the remote control signal transmitter 2, however, the audio comparison part 31 stops outputting the coincidencedetected signal. Upon detecting it (NO in step S15), the control part 37 returns to step S1 and repeats the above-described processing, thereby determining the switched channel. The signal emitted from the remote control signal transmitter 2 at the time of changing the channel of the TV set 1 is received by the remote control signal receiving part 34 of the monitoring apparatus 3, and the contents of the channel information storage part 343 are updated with information about the switched channel. Accordingly, the control part 37 reads out the channel information x from the channel information storage part 343 (step SI), then sets the pointer p accordingly (step S2), and sets the channel C(p) as the channel subject to monitoring (step S3), by which the channel C(p) concerned is determined as the currently selected channel with a high probability. The reason for setting up the condition of high probability is that the signal from the remote control signal transmitter 2 may sometimes fail to reach the remote control signal receiving part 34 under the influence of an obstacle or the like.

As described above, the monitoring apparatus 3 according to this embodiment permits fast and accurate identification of the channel selected on the TC set 1 and detection of the video format in which video of the selected channel is being displayed.

Incidentally, the present invention is not limited specifically to the above-described embodiment but various other additions and modifications can be made as described below.

While in the above the TV set 1 with the VHF/UHF tuner 11 and the BS digital tuner 12 built therein has been exemplified as the TV set to be monitored, the kinds and numbers of built-in tuners are not limited specifically to them. With the monitoring apparatus of the present invention, it is also possible to monitor TV sets which receive BS digital broadcasting or the like by use of STB (Set Top Box).

Although in the above the audio from the loudspeaker of the TV set 1 has been described to be taken out from the loudspeaker output terminal 13, it is also possible to use a configuration that receives the loudspeaker output by a microphone.

In the case of applying the invention to what is called personal audience rating measurement that detects which person of the sample household is watching television, the remote control signal transmitter 2 can also be used as a combination person-identification-signal transmitter and TV remote control as proposed, for example, in Japanese UM Appln. No. 73046/93. Moreover, the present invention is applicable not only to the TV set using the infrared remote control signal transmitter but also to a TV set using a radio remote control signal transmitter.

In the case of an AV-TV set with external input terminals so that it can be used also as a monitor of a video tape recorder or similar AV equipment, the apparatus of the present invention can be adapted to determine first the source of video actually displayed on the TV display and, if the source is a broadcasting wave, proceed to channel monitoring. The source of video displayed can be monitored by use of the method disclosed in U.S. Pat. No. 6,487,719 specification, for instance.

Industrial Applicability

As described above, the channel selecting status monitoring method and apparatus according to the present invention are useful as a TV channel selecting status monitoring method and apparatus which monitor the channel selecting status of the TV placed in a sample household for TV audience rating survey and as a method and apparatus for detecting the kind of the video format in which video of the selected channel is being displayed; in particular, the present invention is suitable for application to a method and apparatus for monitoring the selecting status of a multi-channel television capable of receiving plural kinds of broadcasting, such as analog terrestrial broadcasting and BS digital broadcasting, with one TV set.

1. A TV channel selecting status monitoring method which identifies the channel being actually received by a TV set which has at least one built-in tuner (11, 12) and TV-side remote control signal receiver means (14) for receiving and identifying a remote control signal from a remote control signal transmitter (2) and controlling the channel tuning status of said built-in tuner and which provides video and audio signals of the currently selected channel to a display and a loudspeaker, respectively, said method comprising the steps of:
(a) receiving and identifying the signal from said remote control signal transmitter and determining the channel being received by said TV set; and
(b) controlling the channel tuning status of a reference tuner (32) to bring said audio signals from said reference tuner and said loudspeaker of said TV set into coincidence, said reference tuner being capable of outputting an audio signal of an arbitrary one of a predetermined number of channels;
wherein said step (b) comprises the steps of:
(b-1) when the audio signal from said reference tuner does not coincide with the audio signal from said loudspeaker of said TV set, switching said reference tuner from the channel determined in said step (a) to another one of the predetermined number of channels in a sequential order until said both audio signals coincide with each other;
(b-2) determining, as the currently selected channel. the channel being tuned by said reference tuner at the time when said both audio signals coincide again; and
(b-3) storing in storage means (36) selected-channel data containing information about said channel determined as being currently tuned and the corresponding time information.

2. The TV channel selecting status monitoring method as recited in claim 1, characterized in that:
said method further comprises the step (c) of detecting the kind of the format of video displayed on said display of said TV set, and
the kind of the video format detected in said step (c) is added to the selected-channel data to be stored in said storage means in said step (b-3).

3. The TV channel selecting status monitoring method as recited in claim 2, characterized in that said step (c) comprises the steps of:
(c-1) detecting a horizontal sync signal applied to said display of said TV set;
(c-2) counting the period of said horizontal sync signal detected in said step (c-1); and
(c-3) determining the kind of the format of video currently displayed on said display on the basis of the count value obtained in said step (c-2).

4. The TV channel selecting status monitoring method as recited in claim 1, characterized in that:
said step (b) further comprises the step (b-4) of writing information about the currently selected channel determined in said step (b-2) in a channel information storage part; and
said step (a) comprises the steps of: (a-1) determining the channel to be switched to on the basis of the result of identification of the signal received from said remote control signal transmitter and the currently selected channel information stored in said channel information storage part; and
(a-2) writing information about the channel determined in said step (a-1) in said channel information storage part.

5. The TV channel selecting status monitoring method as recited in claim 1, characterized in that said step (b-1) is a step of: calculating the frequency spectrum of the audio signal from said reference tuner and the frequency spectrum of the audio signal from said loudspeaker of said TV set; and comparing the both frequency spectra to thereby determine whether or not the audio signal from said reference tuner and the audio signal from said loudspeaker of said TV set coincide with each other.

6. A TV channel selecting status monitoring apparatus (3) which identifies the channel being actually received by a TV set (1) which has at least one built-in tuner (11, 12) and TV-side remote control signal receiver means (14) for receiving and identifying a remote control signal from a remote control signal transmitter (2) and controlling the channel tuning status of said built-in tuner and which provides video and audio signals of the currently tuned channel to a display and a loudspeaker, respectively, said apparatus comprising:
a reference tuner (32) capable of outputting an audio signal of an arbitrary one of a predetermined number of channels;
audio comparison means (31) for detecting whether or not the audio signal from said loudspeaker of said TV set and the audio signal from said reference tuner coincide with each other;
monitor-side remote control signal receiver means (34) for receiving and identifying a signal from said remote control signal transmitter to determine the channel currently selected by said TV set;
control means (37) which: controls the channel tuning status of said reference tuner so that the output from said audio comparison means remains coincidence-detected; when the coincidence-detected output from the audio comparison means changes to a noncoincidence-detected output, switches said reference tuner from the channel determined by said monitorside remote control signal receiver means to another one of the predetermined number of channels in a sequential order until the channel of said reference tuner is found for which coincidence is detected by said audio comparison means; determines, as the currently selected channel, the channel currently tuned by said reference tuner for which the output from said audio comparison means becomes the coincidence-detected output again; and outputs selected-channel data containing information about said channel determined as being currently selected and the corresponding time information; and
storage means (36) for storing said selected-channel data provided from said control means.

7. The TV channel selecting status monitoring apparatus as recited in claim 6, characterized in that: said apparatus further comprises video format detecting means for detecting the kind of the format of video displayed on said display of said TV set; and said control means adds the detection result by said video format detecting means to said selected-channel data.

8. The TV channel selecting status monitoring apparatus as recited in claim 7, wherein said video format detecting means comprises: sync signal detecting means (15, 331) for detecting a horizontal sync signal applied to said display of said TV set; a counter (333) for counting the period of the horizontal sync signal detected by said sync signal detecting means; and format determining means (337) for determining the kind of the format of video displayed on said display on the basis of the count value of said counter.

9. The TV channel selecting status monitoring apparatus as claimed in claim 6, characterized in that said monitor-side remote control signal receiver means comprises: channel information storage part (343) in which is written the information about the currently selected channel detected by said control means; and an identification part (342) for determining the channel to be switched to and writing information about said determined channel in said channel information storage part.

10. The TV channel selecting status monitoring apparatus as claimed in claim 6, characterized in that:
said reference tuner is a tuner of the same kind as said built-in tuner and has: a plurality sets of a monitor-side tuner (321, 323) whose channel tuning status is controlled by said control means and audio demodulating means (322, 324) for demodulating right- and left-side audio signals from the output of said monitor-side tuner, said plurality sets being equal in number to the kinds of said built-in tuners in said TV set; and a first analog switch (325) for outputting therethrough right- and left-side audio signals provided from said audio demodulating means in that one of said plurality of sets which is specified by said control means; and
said audio comparison means comprises: a second analog switch (311) for selecting that one of right- and left-side audio signals taken out from loudspeaker output terminals of said TV set which is specified by said control means; a third analog switch (313) for selecting that one of right- and left-audio signals from said reference tuner which is specified by said control means; a first operator (312) for performing a fast Fourier transform for the audio signal having passed through said second analog switch; a second operator (314) for performing a fast Fourier transform for the audio signal having passed through said third analog switch; and a comparator (315) for comparing the operation result by said first operator and the operation result by said second operator and for providing the comparison result as the detected output to said control means.
